(19) United States
(12) Patent Application Publication
(10) Pub. No.: US 2026/0329114 A1
(43) Pub. Date: Oct. 22, 2026

(54) Semiconductor Optical Waveguide and Manufacturing Method Thereof

(71) Applicant: NTT, Inc., Tokyo (JP)

(72) Inventor: Yuta Ueda, Musashino-shi, Tokyo (JP)

(21) Appl. No.: 19/114,771

(22) PCT Filed: Oct. 21, 2022
(86) PCT No.: PCT/JP2022/039382

§ 371 Date: Mar. 24, 2025

(51) Int. Cl. G02F 1/025

(52) U.S. Cl. CPC G02F 1/025

(57) ABSTRACT

Provided are a semiconductor optical waveguide and a manufacturing method thereof, in which a waveguide width can be made narrow and a resistance can be made low, while suppressing crystal defects in a core layer. The semiconductor optical waveguide according to the present disclosure includes a substrate; a core layer formed on the substrate; an over-clad layer formed on the core layer; a contact layer installed on the over-clad layer; a cavity formed in the over-clad layer; a groove formed in the over-clad layer and the contact layer and connected to the cavity; a first electrode connected to the substrate; and a second electrode connected to the contact layer.

### TECHNICAL FIELD

The present disclosure relates to a semiconductor optical waveguide and a manufacturing method thereof.

### BACKGROUND ART

Semiconductor optical waveguides not only form an optical circuit by guiding light but also can control a state of guided light by applying electrical signals such as a current and an electric field to the waveguide. Typical examples of a semiconductor optical waveguide include a semiconductor laser using a compound semiconductor, and the like, which has been put into practical use in various fields such as in optical communication.

FIG. 1 is a perspective view schematically showing a structure and a manufacturing process of a semiconductor optical waveguide 100c using a compound semiconductor according to the related art, FIG. 1(a) shows a state of a semiconductor multilayer film 100a as a base of the semiconductor optical waveguide 100c, FIG. 1(b) shows a state of a semiconductor multilayer film 100b from which an over-clad layer 103 of the semiconductor multilayer film 100a is removed, and FIG. 1(c) shows a state of the over-clad layer 103 and the semiconductor optical waveguide 100c in which an electrode is formed on a substrate 101, respectively. The semiconductor optical waveguide 100c shown in FIG. 1 is explained as an example of a semiconductor optical waveguide using an indium phosphorus (InP)-based compound semiconductor.

As shown in FIG. 1(a), the semiconductor optical waveguide 100c is manufactured from the semiconductor multilayer film 100a. The semiconductor multilayer film 100a includes a substrate 101, a core layer 102 formed on the substrate 101, and an over-clad layer 103 formed on the core layer 102. When the semiconductor multilayer film 100a is an InP-based film, n-type doped InP (hereinafter referred to as n-InP) is adopted for the substrate 101, indium gallium arsenide phosphorus (hereinafter referred to as i-InGaAsP) having a refractive index higher than that of InP and not doped with impurities (intrinsic) is adopted for the core layer 102, and p-type doped InP (hereinafter referred to as p-InP) is adopted for the over-clad layer 103.

By removing a part (other than a portion corresponding to a waveguide region to be described later) of the over-clad layer 103 of the semiconductor multilayer film 100a having such a configuration, a semiconductor multilayer film 100b as shown in FIG. 1(b) is formed. The method of removing a part of the over-clad layer 103 may be, for example, dry etching by high-speed ion beam irradiation. In the semiconductor multilayer film 100b formed in this way, light guided in the core layer 102 is confined in a region (waveguide region) shown by a broken line in FIG. 1 on the basis of the refractive index difference between the core layer 102 and the substrate 101 and the over-clad layer 103. In the waveguide region, the light travels in the x-direction to guide the light. A waveguide having such a configuration is generally called a ridge type waveguide. Further, the semiconductor multilayer film 100b is stacked in the order of a p-type semiconductor (over-clad layer 103), a semiconductor without added impurities (intrinsic) (core layer 102), and an n-type semiconductor (substrate 101) in a thickness direction (z-direction). The semiconductor multilayer film having such a stacked configuration is generally called a pin diode. That is, it can be said that the semiconductor multilayer film 100b is a ridge type waveguide having a structure of a pin diode.

By installing electrodes 104 and 105 on each of a lower face (a surface that is not in contact with the core layer 102 and parallel to an xy plane) of the substrate 101 and an upper face (similarly, a surface that is not in contact with the core layer 102 and parallel to the xy plane) of the over-clad layer 103 for the semiconductor multilayer film 100b having such a configuration, a semiconductor optical waveguide 100c shown in FIG. 1(c) is manufactured. By applying a voltage between the electrode 104 and the electrode 105, the light guided in the core layer 102 can be controlled. For example, when an electrically positive voltage is applied (forward bias) to the over-clad layer 103 with respect to the substrate 101, holes are injected through the over-clad layer 103 for which p-InP has been adopted, and electrons are injected through the substrate 101 to which n-InP is applied, into the core layer 102 to which i-InGaAsP is applied, respectively. Accordingly, the values of physical properties of i-InGaAsP are changed by the charge of electrons and holes.

Conversely, when an electrically negative voltage is applied (reverse bias) to the over-clad layer 103 with respect to the substrate 101, charges are not injected into the core layer 102 to which i-InGaAsP is applied, and the physical property value of i-InGaAsP is changed by applying an electric field.

In general, the ridge type waveguide as illustrated in FIG. 1 can be manufactured by removing only a part of the over-clad layer after a basic semiconductor multilayer film 100a is obtained. Therefore, although there is an advantage of having the simple manufacturing process, on the other hand, there is also a disadvantage of having a low degree of freedom of design of a waveguide width and electrical resistance.

If the waveguide width is greater than a certain width, there is a likelihood that an unintended higher-order waveguide mode is excited, and accordingly, the performance of the optical device to which the ridge type waveguide is applied may be deteriorated. On the other hand, when the width of the waveguide is reduced, there is a problem of an increase in the electric resistance of the waveguide accordingly. In particular, in the case of the semiconductor laser described above, since the electric resistance of the waveguide increases, the Joule heat caused by the current flowing through the waveguide also increases. In general, since semiconductor lasers undergo significant deterioration in characteristics due to heat, it is desirable to keep such Joule heat low, and therefore it is desirable to use a waveguide having a small electric resistance.

An existing solution for such a problem, that is, a structure of a semiconductor optical waveguide capable of suppressing electric resistance low while narrowing a waveguide width, is an embedded waveguide (see, for example, NPL 1).

FIG. 2 is a perspective view schematically showing a structure and a manufacturing process of an exemplary embedded semiconductor optical waveguide 200c according to the related art, FIG. 2(a) shows a basic semiconductor multilayer film 200a, FIG. 2(b) shows a semiconductor multilayer film 200b before forming an electrode, and FIG. 2(c) shows a semiconductor optical waveguide 200c in a state after the electrode is formed. Also in FIG. 2, as in FIG. 1, the semiconductor optical waveguide 200c is, for example, shown as a semiconductor optical waveguide that uses an indium phosphorus (InP)-based compound semiconductor.

As shown in FIG. 2(a), the semiconductor multilayer film 200a as a base of the embedded semiconductor optical waveguide 200c has the same configuration as the semiconductor multilayer film 100a in FIG. 1(a). For the semiconductor multilayer film 200a having such a configuration, a part of the semiconductor multilayer film 200a is removed in the same manner as a manufacturing process of the semiconductor multilayer film 100b. However, at this time, in the manufacturing process of the embedded semiconductor optical waveguide 200c, the removal is performed not only via the over-clad layer 203 but also via the core layer 202 to the region of the substrate 201. Thereafter, the removed region is buried with a semiconductor BH206 having a buried heterostructure, and the semiconductor multilayer film 200b is formed. In FIG. 2(b), as an example, the semiconductor BH206 has a structure in which an n-InP layer 206b is inserted into a part of a p-InP206a.

In the semiconductor multilayer film 200b having such a configuration, the width of the core layer 202 in the y-direction become narrower than that of the semiconductor multilayer film 100b which is the ridge type waveguide. Further, since both sides of the core layer 202 in the y-direction also have a structure in which InP having a refractive index equal to that of the substrate 201 and the over-clad layer 203 is embedded, the light confinement effect in a lateral direction (y-direction) is also enhanced.

In addition, the semiconductor BH206 has a pnp junction in the thickness direction (z-direction). Since such a pnp structure substantially has two pn junctions, for example, when the potential on the side of the over-clad layer 203 with respect to the substrate 201 is made positive, since a pn interface on the substrate 201 side is in a reverse bias state called a diode, no current flows. That is, although embedded in the semiconductor BH206, the current is injected only into the core layer 202. As a result, the spread of the current is suppressed, and the light confinement effect in the lateral direction (y-direction) is further enhanced.

By installing electrodes 204 and 205 on each of the lower face of the substrate 201 and the upper face of the over-clad layer 103, with respect to the semiconductor multilayer film 200b having such a configuration, the semiconductor optical waveguide 200c shown in FIG. 2(c) is manufactured.

As shown in FIG. 2(c), the semiconductor optical waveguide 200c having the embedded waveguide structure has a larger area of the surface, on which the electrode 205 is installed, than that of the semiconductor optical waveguide 100c having the ridge type waveguide structure. Therefore, the electrode 205 can be installed over the entire surface of the xy plane of the over-clad layer 203, and as a result, the electric resistance of the waveguide can be reduced.

In this way, the embedded semiconductor optical waveguide such as the semiconductor optical waveguide 200c can reduce the resistance value of the waveguide, while narrowing the width of the waveguide as compared with the ridge type waveguide such as the semiconductor optical waveguide 100c. Therefore, high device performance can be achieved by excitation of higher-order waveguide modes and reduction of Joule heat generation.

However, in such an embedded waveguide, the core layer is also subjected to processing such as etching in the manufacturing process. Therefore, crystal defects may occur in the core layer, and as a result, there is a problem that it is difficult to secure the reliability of the device.

### CITATION LIST

### Non Patent Literature

[NPL 1] Atsutoshi Doi, Michiharu Nakamura,. “InGaAsP/InP Buried Heterostructure Semiconductor lasers”, Hitachi Hyoron, Vol. 61, No. 11, pp 39-42 (1979)

### SUMMARY OF INVENTION

The present disclosure has been made in view of the above-mentioned problems, and an object of the present disclosure is to provide a semiconductor optical waveguide capable of reducing a waveguide width and obtaining a low resistance, while suppressing crystal defects in a core layer, and a manufacturing method thereof.

In order to solve the above problem, the present disclosure provides a semiconductor optical waveguide including a substrate; a core layer formed on the substrate; an over-clad layer formed on the core layer; a contact layer installed on the over-clad layer; a cavity formed in the over-clad layer; a groove formed in the over-clad layer and the contact layer and connected to the cavity; a first electrode connected to the substrate; and a second electrode connected to the contact layer.

Further, the present disclosure provides a method for manufacturing a semiconductor optical waveguide, the method including: preparing a semiconductor multilayer film in which a core layer is formed on a substrate, an over-clad layer is formed on the core layer, and a sacrificial layer is further formed on the over-clad layer; removing a region corresponding to a waveguide width in the sacrificial layer; depositing the same material as the over-clad layer above the over-clad layer and the sacrificial layer to further form a contact layer on the deposited over-clad layer; forming a groove connected to the sacrificial layer on a main face of the remaining sacrificial layer and on an outside of a side face of the remaining sacrificial layer on the waveguide region side; removing the remaining sacrificial layer to form a cavity; and connecting a first electrode and the substrate, and connecting a second electrode and the contact layer, respectively.

### BRIEF DESCRIPTION OF DRAWINGS

FIG. 1 is a perspective view schematically showing a structure and a manufacturing process of a semiconductor optical waveguide 100c using a compound semiconductor according to the related art, FIG. 1(a) shows a state of a semiconductor multilayer film 100a as a base of a semiconductor optical waveguide 100c, FIG. 1(b) shows a state of a semiconductor multilayer film 100b from which an over-clad layer 103 of the semiconductor multilayer film 100a is removed, and FIG. 1(c) shows a state of the semiconductor optical waveguide 100c in which an electrode is formed on the over-clad layer 103 and the substrate 101, respectively.

FIG. 2 is a perspective view schematically showing a structure and a manufacturing process of an exemplary embedded semiconductor optical waveguide 200c according to the related art, FIG. 2(a) is a semiconductor multilayer film 200a as a base, FIG. 2(b) is a semiconductor multilayer film 200b in a state before forming an electrode, and FIG. 2(c) is a semiconductor optical waveguide 200c in a state after forming the electrode, respectively.

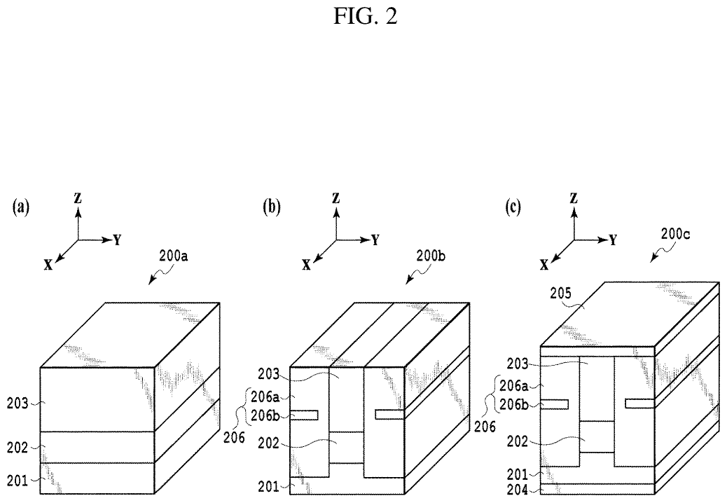

FIG. 3 is a diagram showing a structure of a semiconductor optical waveguide 300 according to the present disclosure, FIG. 3(a) is a perspective view, FIG. 3(b) is a top view, and FIG. 3(c) is a cross-sectional view taken along a IIIc-IIIc cross-sectional line.

FIG. 4 is a diagram showing a structure of a semiconductor optical waveguide 400 according to the present disclosure, FIG. 4(a) is a perspective view, FIG. 4(b) is a top view, and FIG. 4(c) is a cross-sectional view taken along a IVc-IVc cross-sectional line.

FIG. 5 is a diagram showing a structure of a semiconductor optical waveguide 500 according to the present disclosure, FIG. 5(a) is a perspective view, FIG. 5(b) is a top view, and FIG. 5(c) is a cross-sectional view taken along a Vc-Vc cross-sectional line.

FIG. 6 is a diagram showing a structure of the semiconductor optical waveguide 500 according to the present disclosure, FIG. 6(a) is a perspective view, FIG. 6(b) is a top view, and FIG. 6(c) is a cross-sectional view taken along a VIc-VIc cross-sectional line.

FIG. 7 is a flowchart showing a method 700 for manufacturing the semiconductor optical waveguide 300 according to the present disclosure.

FIG. 8 is a perspective view showing a structure of a semiconductor multilayer film 800 prepared in S701.

FIG. 9 is a perspective view showing a structure of a semiconductor multilayer film 900 formed in S702.

FIG. 10 is a perspective view showing a structure of a semiconductor multilayer film 1000 formed in S703.

FIG. 11 is a perspective view showing a structure of a semiconductor multilayer film 1100 formed in S704.

### DESCRIPTION OF EMBODIMENTS

Various embodiments of the present disclosure are described hereinafter in detail with reference to the drawings. The same or similar reference numerals indicate the same or similar elements and repeated description thereof may be omitted. Materials and numerical values are intended for illustration and are not intended to limit the technical scope of the present disclosure. The following description is an example, and some configurations may be omitted or modified, or may be implemented with additional configurations, unless it departs from the gist of one embodiment of the present disclosure.

Further, in the following description, the semiconductor optical waveguide according to the present disclosure isdescribed as a semiconductor optical waveguide using an InP-based compound semiconductor, but this is intended for the purpose of illustration and is not intended to be limiting to an InP-based compound semiconductor.

Hereinafter, a configuration of a semiconductor optical waveguide 300 according to an embodiment of the present disclosure isdescribed in detail with reference to the drawings.

### Configuration of Semiconductor Optical Waveguide

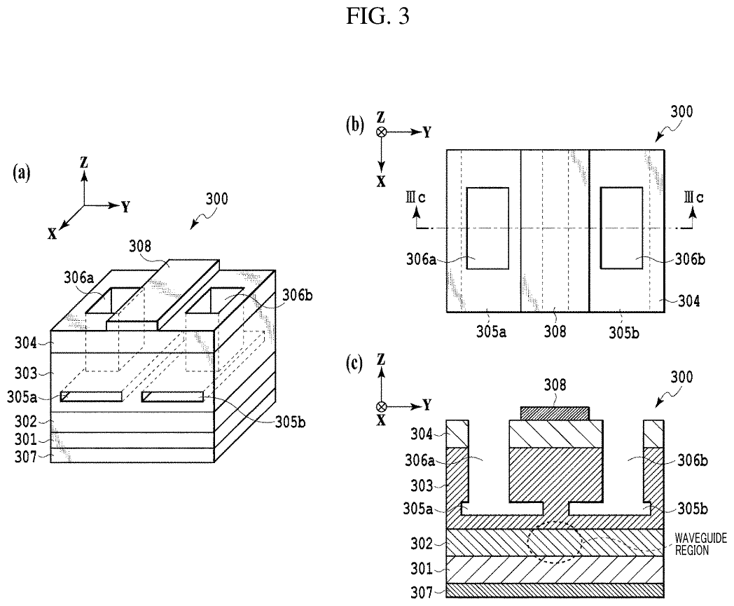

FIG. 3 is a diagram showing the structure of the semiconductor optical waveguide 300 according to the present disclosure, FIG. 3(a) is a perspective view, FIG. 3(b) is a top view, and FIG. 3(c) is a cross-sectional view taken along a IIIc-IIIc cross-sectional line. As shown in FIG. 3, the semiconductor optical waveguide 300 includes a substrate 301, a core layer 302 formed on the substrate 301, an over-clad layer 303 formed on the core layer 302, a contact layer 304 installed on the over-clad layer 303, cavities 305a and 305b formed on the over-clad layer 303, grooves 306a and 306b formed in the over-clad layer 303 and the contact layer 304 and connected to the cavities 305a and 305b, an electrode 307 installed on the lower face of the substrate 301, and an electrode 308 installed on the upper face of the contact layer 304.

As an example, in the same way as the semiconductor optical waveguides 100c and 200c, n-InP is applied to the substrate 301, i-InGaAsP is applied to the core layer 302, and p-InP is applied to the over-clad layer 303, respectively. The contact layer 304 is a layer for improving an electrical contact between the electrode 308 and the over-clad layer 303, and for example, p-InGaAs or the like can be applied. The electrodes 307 and 308 may be a metal or the like having excellent conductivity.

The cavity 305a and the groove 306a, and the cavity 305b and the groove 306b have a substantially connected structure. In other words, the grooves 306a and 306b are through-grooves having a depth from the upper face of the contact layer 304 to the upper faces of the cavities 305a and 305b. In addition, the side faces of the grooves 306a and 306b on the waveguide region side (side faces parallel to the xz plane) are formed to be positioned outside the side faces of the cavities 305a and 305b on the waveguide region side.

By forming the cavities 305a and 305b and the grooves 306a and 306b in this way, the over-clad layer 303 having an inverted convex shape is formed on the upper part of the waveguide region of the semiconductor optical waveguide 300. Due to the shape of the inverted convex shape, the width of the over-clad layer 303 in the y-direction becomes narrow in the waveguide region in which the over-clad layer 303 and the core layer 302 are in contact with each other, and the waveguide width becomes narrow accordingly. On the other hand, upper faces (faces on which the electrodes 308 are installed) of the over-clad layer 303 and the contact layer 304 become wider than a ridge type semiconductor optical waveguide (for example, a semiconductor optical waveguide 100c) according to the related art, and as a result, it is possible to obtain the semiconductor optical waveguide having a lower resistance than the ridge type semiconductor optical waveguide according to the related art.

The semiconductor optical waveguide 300 having such a configuration does not have an embedded structure in which the side face of the core layer 302 in the y-direction is covered with a clad. Therefore, in the manufacturing of the semiconductor optical waveguide 300, processing such as removal of the core layer 302 is not required, and an occurrence of crystal defects in the core layer 302 can be suppressed. As a result, the semiconductor optical waveguide 300 can easily secure the reliability of the device as compared with the semiconductor optical waveguide according to the related art.

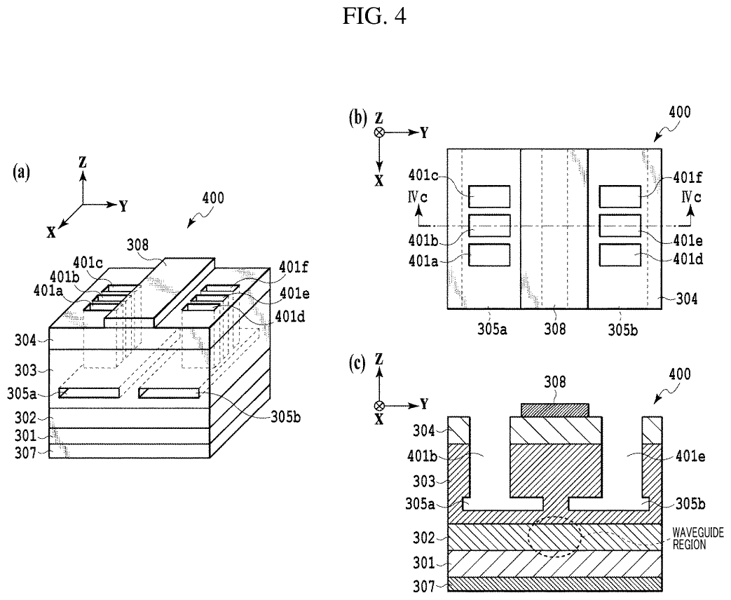

In FIG. 3, although the grooves 306a and 306b are depicted as one groove continuously extending in the x-direction (direction parallel to an optical axis direction), as shown in the semiconductor optical waveguide 400 shown in FIG. 4, they may have a structure having grooves 401a to 401c and 401d to 401f divided into a plurality of parts. Because the semiconductor optical waveguide 400 having the divided grooves 401a to 401c and 401d to 401f improves the rigidity of the over-clad layer 303, mechanical strength can be secured.

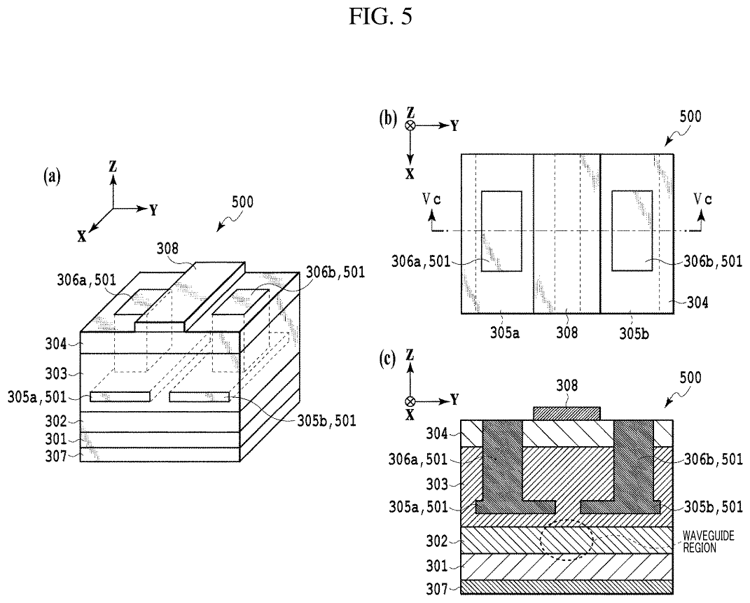

Also, the cavities 305a and 305b and the grooves 306a and 306b may be hollow, alternatively, as shown in FIG. 5, a filler material 501 having a high insulating property and a low refractive index may be filled. The filler material 501 can be, for example, benzocyclobutene (BCB), or a material such as formed of Spin-on-Glass (SOG) in the manufacturing of general semiconductors (e.g., silica glass and the like).

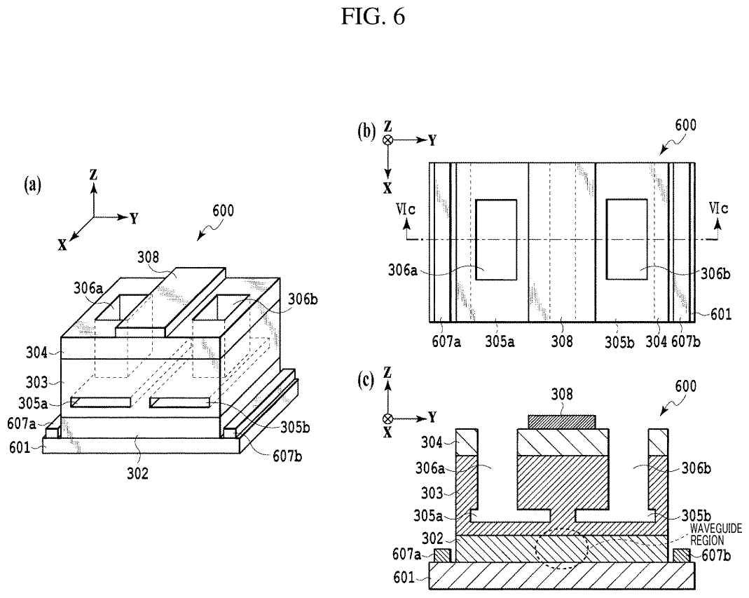

In addition, in FIG. 3, although the substrate 301, the core layer 302, the over-clad layer 303, and the contact layer 304 are depicted so that the lengths in the x-direction and the widths in the y-direction are all the same, a substrate 601 having a width in the y-direction larger than a width in the y-direction of the core layer 302 (having a main surface wider than that of the core layer 302) may be used like a semiconductor optical waveguide 600 shown in FIG. 6, and the electrodes 607a and 607b may be installed on the upper face of the substrate 601. Such a configuration of the semiconductor optical waveguide 600 can be regarded as a ground-signal-ground (GSG) high-frequency circuit, and can also be a configuration of a modulator represented by a Mach-Zehnder modulator.

Hereinafter, a method 700 for manufacturing a semiconductor optical waveguide according to the present disclosure isdescribed in detail with reference to the drawings.

### Method for Manufacturing Semiconductor Optical Waveguide

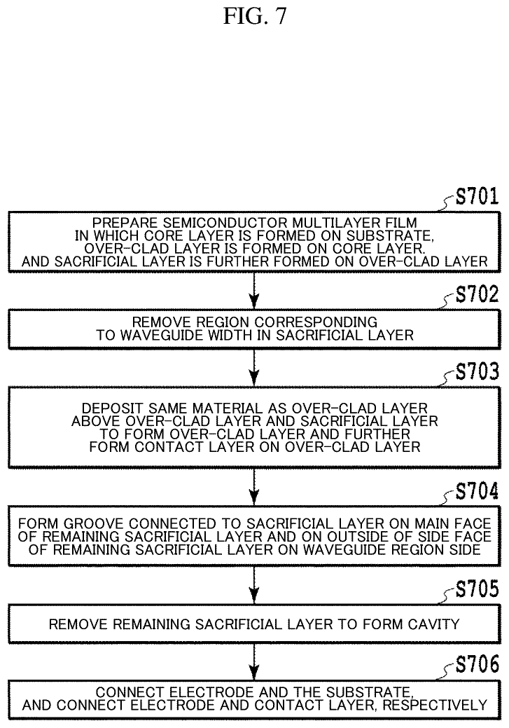

FIG. 7 is a flowchart illustrating a method 700 for manufacturing the semiconductor optical waveguide 300 according to the present disclosure. The method 700 for manufacturing the semiconductor optical waveguide 300 according to the present disclosure includes: preparing a semiconductor multilayer film 800 in which the core layer 302 is formed on the substrate 301, the over-clad layer 303a is formed on the core layer 302, and a sacrificial layer 801 is formed on the over-clad layer 303a (S701); removing a region corresponding to a waveguide width in the sacrificial layer 801 (S702); depositing the same material as the over-clad layer 303a above the over-clad layer 303a and the sacrificial layer 801 to form an over-clad layer 303, and further forming the contact layer 304 on the over-clad layer 303 (S703); forming grooves 306a and 306b connected to the sacrificial layer 801 on the main face of the remaining sacrificial layer 801 and on the outside of the side face of the remaining sacrificial layer 801 on the waveguide region side (S704); removing the remaining sacrificial layer 801 to from cavities 305a and 305b (S705); and connecting the electrode 307 and the substrate 301, and connecting the electrode 308 and the contact layer 304, respectively (S706).

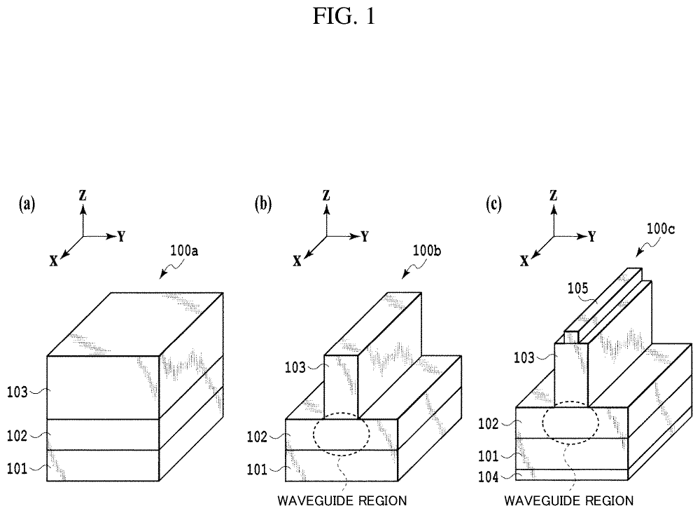

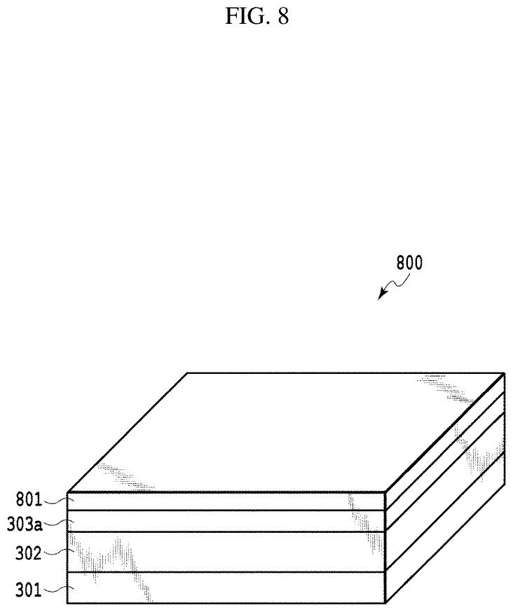

FIG. 8 is a perspective view showing the structure of a semiconductor multilayer film 800 prepared in S701. The semiconductor multilayer film 800 has a structure in which a sacrificial layer 801 is further formed on the over-clad layer 103 in the semiconductor multilayer film 100a shown in FIG. 1. In the method 700 for manufacturing the semiconductor optical waveguide 300 according to the present disclosure, the semiconductor multilayer film 800 is used as a base, and the sacrificial layer 801 is used as subsequent cavities 305a and 305b. For example, indium gallium arsenide (InGaAs) may be applied to the sacrificial layer 801. Here, as an example, the thicknesses of the over-clad layer 303 and the sacrificial layer 801 are 100 nm, respectively.

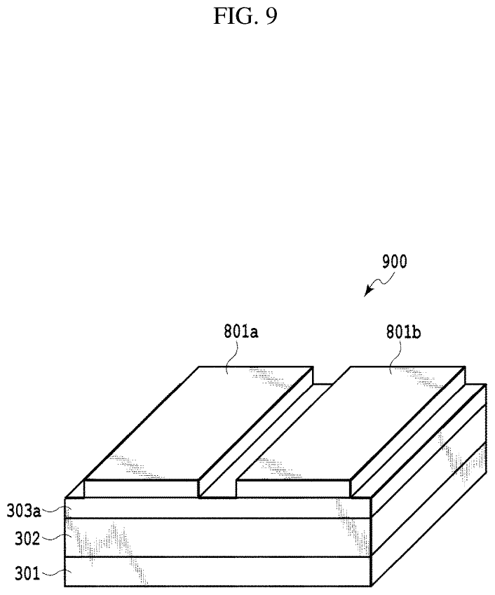

FIG. 9 is a perspective view showing the structure of the semiconductor multilayer film 900 formed in S702. The semiconductor multilayer film 900 has a structure in which a region corresponding to the waveguide width is removed in the sacrificial layer 801 of the semiconductor multilayer film 800 shown in FIG. 8. The width of the region to be removed in the y-direction corresponds to the waveguide width of the semiconductor optical waveguide 300. Here, as an example, the width of the region to be removed in the y-direction is 2 μm. The removal method may be, for example, wet etching using p-InP and a selective etchant, dry etching using high-speed ion beam irradiation, and the like. If necessary, masking may be applied to the upper face of the remaining portion of the sacrificial layer 801.

In S702, the widths of the sacrificial layers 801a and 801b to be left in the y-direction are required to be 1 μm or more from the viewpoint of manufacturability. In FIG. 9, although the region of the sacrificial layer 801 on the opposite side of the waveguide region is also depicted to be removed, the region on the opposite side may be removed as long as the width of the remaining sacrificial layers 801 a and 801 b in the y-direction is maintained to be 1 μm or more.

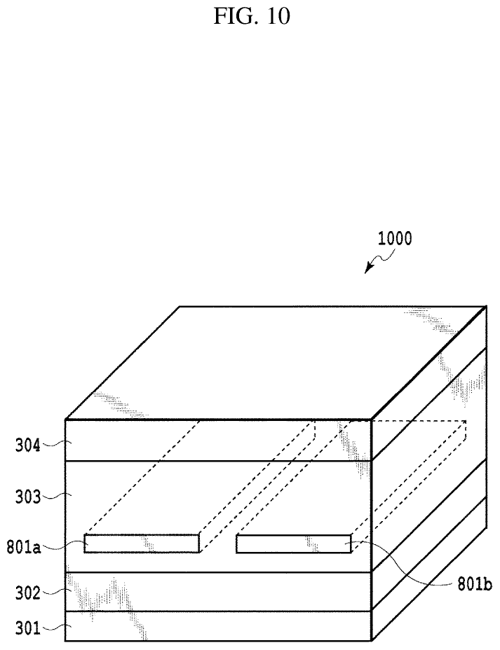

FIG. 10 is a perspective view showing the structure of the semiconductor multilayer film 1000 formed in S703. The semiconductor multilayer film 1000 has a structure in which sacrificial layers 801a and 801b remaining in the semiconductor multilayer film 900 are embedded in the over-clad layer 303, and the contact layer 304 is further formed on the over-clad layer 303.

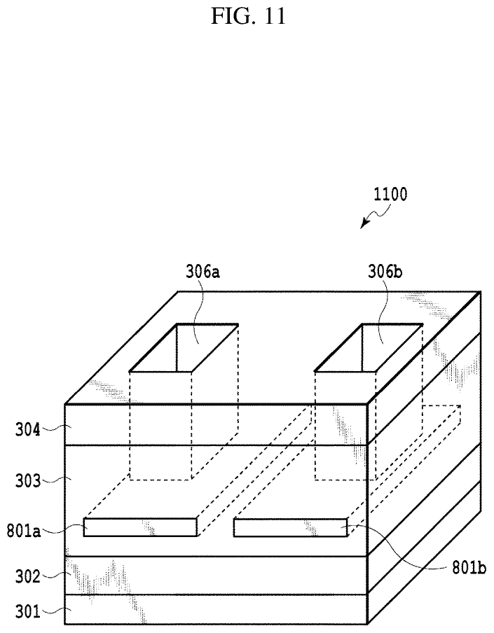

FIG. 11 is a perspective view showing the structure of the semiconductor multilayer film 1100 formed in S704. The semiconductor multilayer film 1100 has a structure in which grooves 306a and 306b are formed in the over-clad layer 303 of the semiconductor multilayer film 1000. When the grooves 306a and 306b are formed, the side faces of the grooves 306a and 306b on the waveguide region side (side faces parallel to the xz plane) are required to be formed to be positioned outside the side face on the waveguide region side of the remaining sacrificial layers 801a and 801b (to make the over-clad layer 303 positioned above the waveguide region have an inverted convex shape). Since the cavities 305a and 305b formed later and the grooves 306a and 306b are required be connected to each other, the grooves 306a and 306b are required be formed to a depth at which the sacrificial layer 801 is exposed to the bottom face. The method for forming the grooves 306a and 306b may be, for example, dry etching by a high-speed ion irradiation.

Finally, by removing the sacrificial layer 801 in S705, and by connecting the electrode 307 and the substrate 301 and the electrode 308 and the contact layer 304 in S706, the semiconductor optical waveguide 300 is manufactured. The method for removing the sacrificial layer 801 can be, for example, wet etching using p-InP and a selective etchant. If necessary, masking may be applied to the upper face and side faces of the contact layer 304 so that the contact layer 304 is not affected by etching.

As described above, the semiconductor optical waveguide according to the present disclosure may have a structure having a plurality of divided grooves 401a to 401c and 401d to 401f, as in the semiconductor optical waveguide 400 shown in FIG. 4. In order to form such grooves 401a to 401c and 401d to 401f, a part of the contact layer 304 and the over-clad layer 303 may be removed to remain in S704 of the manufacturing method 700. Specifically, for example, masking is applied to the upper face of the portion to be left.

Also, as described above, the semiconductor optical waveguide according to the present disclosure may have cavities 305a and 305b and the grooves 306a and 306b filled with a filler material 501 having high insulation properties and a low refractive index as in the semiconductor optical waveguide 500 shown in FIG. 5. In order to manufacture such a semiconductor optical waveguide 500, the cavities 305a and 305b and the grooves 306a and 306b may be filled with a filler material 501 after S704 of the manufacturing method 700.

In addition, as described above, the semiconductor optical waveguide according to the present disclosure may have a length in the x-direction and a width in the y-direction of the substrate 301 larger than those of the core layer 302, and the electrode 307 may be installed on the upper face of the substrate 301 as in the semiconductor optical waveguide 600 shown in FIG. 6. In order to manufacture such a semiconductor optical waveguide 600, the substrate 301 having a principal surface wider than the core layer 302 is used in S701 of the manufacturing method 700, and in S706, the electrode 307 is installed on the upper face of the substrate 301.

### Industrial Applicability

As described above, because the semiconductor optical waveguide according to the present disclosure has a narrow waveguide width and a low resistance while suppressing the occurrence of crystal defects in the core layer, higher reliability and device performance can be realized as compared with the semiconductor optical waveguide according to the related art. Such an optical semiconductor optical waveguide is expected to be applied to an optical device or the like in an optical communication network in which a large capacity is desired.

1. A semiconductor optical waveguide comprising:
a substrate;
a core layer formed on the substrate;
an over-clad layer formed on the core layer;
a contact layer installed on the over-clad layer;
a cavity formed in the over-clad layer;
a groove formed in the over-clad layer and the contact layer and connected to the cavity;
a first electrode connected to the substrate; and
a second electrode connected to the contact layer.

2. The semiconductor optical waveguide according to claim 1,
wherein the groove is divided into a plurality of grooves with respect to a direction parallel to an optical axis direction.

3. The semiconductor optical waveguide according to claim 1,
wherein the groove is filled with a filling material being highly insulating and having a low refractive index.

4. The semiconductor optical waveguide according to claim 1,
wherein a main face of the substrate is wider than a main face of the core layer, and
the first electrode is installed on an upper face of the substrate.

5. A method for manufacturing a semiconductor optical waveguide, the method comprising:
preparing a semiconductor multilayer film that a core layer is formed on a substrate, an over-clad layer is formed on the core layer, and a sacrificial layer is further formed on the over-clad layer;
removing a region corresponding to a waveguide width in the sacrificial layer;
depositing the same material as that of the over-clad layer above the over-clad layer and the sacrificial layer to further form a contact layer on the deposited over-clad layer;
forming a groove connected to the sacrificial layer on a main face of the remaining sacrificial layer and on an outside of a side face of the remaining sacrificial layer on the waveguide region side;
removing the remaining sacrificial layer to form a cavity; and
connecting a first electrode and the substrate, and connecting a second electrode and the contact layer, respectively.

6. The method for manufacturing the semiconductor optical waveguide according to claim 5, further comprising:
removing the contact layer and the over-clad layer such that a part thereof remains in the forming of the grooves.

7. The method for manufacturing the semiconductor optical waveguide according to claim 5, further comprising:
filling the cavities and the grooves with a filler material being highly insulating and having a low refractive index after the forming the grooves.

8. The method for manufacturing the semiconductor optical waveguide according to claim 5,
wherein in the preparing the semiconductor multilayer film, a main face of the substrate is wider than a main face of the core layer, and
in the connecting the first electrode, the first electrode is connected to an upper face of the substrate.
